(19) United States
(12) Patent Application Publication
(10) Pub. No.: US 2015/0237287 A1
(43) Pub. Date: Aug. 20, 2015

(54) SOLID-STATE IMAGING APPARATUS AND CAMERA SYSTEM

(71) Applicant: KABUSHIKI KAISHA TOSHIBA, Minato-ku (JP)

(72) Inventors: Yukiyasu TATSUZAWA, Yokohama-shi (JP); Tatsuji ASHITANI, Yokohama-shi (JP); Kazuhiro HIWADA, Yokohama-shi (JP)

(73) Assignee: KABUSHIKI KAISHA TOSHIBA, Minato-ku (JP)

(21) Appl. No.: 14/338,492

(22) Filed: Jul. 23, 2014

(30) Foreign Application Priority Data
Feb. 20, 2014 (JP) 2014-030554

(51) Int. Cl. H04N 5/376; H04N 5/378; H04N 5/369

(52) U.S. Cl. CPC H04N 5/3765; H04N 5/369; H04N 5/378

(57) ABSTRACT

According to one embodiment, a solid-state imaging apparatus includes a pixel array, a first vertical signal line, a second vertical signal line, and a control unit. Each of cells includes a plurality of pixels. The first vertical signal line is connected to first cells. The second vertical signal line is connected to second cells. The control unit generates a timing signal. In each of the cells, two pixels are arrayed in a horizontal direction and at least two pixels are arrayed in a vertical direction. The control unit prioritizes ordering of pixels selected from the plurality of pixels to cause timings to read signals from the selected pixels to continue in the vertical direction. The control unit generates a timing signal that prioritizes ordering of the selected pixels over other pixels.

### CROSS-REFERENCE TO RELATED APPLICATIONS

This application is based upon and claims the benefit of priority from Japanese Patent Application No. 2014-030554, filed on Feb. 20, 2014; the entire contents of all of which are incorporated herein by reference.

### FIELD

Embodiments described herein relate generally to a solid-state imaging apparatus and a camera system.

### BACKGROUND

There is known an image sensor of a solid-state imaging apparatus, in which cells each being composed of a predetermined number of pixels are arranged in a horizontal direction (a row direction) and a vertical direction (a column direction). Each of the cells has a predetermined number of photoelectric conversion elements connected to one output circuit. Each of the cells outputs signals from the photoelectric conversion elements one by one to a vertical signal line connected to the output circuit. By handling the plural pixels as one cell, the solid-state imaging apparatus can increase the quantity of saturation charges, enhance the sensitivity, and reduce random noises.

When it is assumed that a plurality of pixels arrayed in the horizontal direction is included in each cell, an image sensor reads signals of the pixels arrayed in the horizontal direction in each cell at different timings. In this case, the image sensor reads an image at a speed lower than a case where signals of pixels in each row are simultaneously read. To increase the speed of Image reading from an image sensor, an image sensor in which a plurality of vertical signal lines is provided for one column of cells is sometimes used. This image sensor reads signals from cells connected to different vertical signal lines at the same time.

When an image sensor adopting a rolling shutter takes an image of a moving object that is moving at a high speed, there are differences in read timings in the vertical direction and thus distortion may occur in the image of the moving object. The image sensor may cause noises (jaggies) in a pattern shape at boundary portions in the image of the moving object because read timings of signals in each row vary for the differences in read timings that produce the distortion in the image. Furthermore, because the differences in read timings vary according to colors, the image sensor may cause color deviation (false colors) at the boundary portions in the image of the moving object. In the solid-state imaging apparatus, when the jaggies or false colors occur markedly, the image quality further degrades in addition to the phenomenon due to the rolling shutter.

### BRIEF DESCRIPTION OF THE DRAWINGS

FIG. 1 is a block diagram illustrating a schematic configuration of a solid-state imaging apparatus according to a first embodiment;

FIG. 2 is a block diagram illustrating a schematic configuration of a camera system including the solid-state imaging apparatus;

FIG. 3 is a schematic configuration diagram of a pixel array;

FIG. 4 is an explanatory diagram of timings when an image sensor according to a comparative example reads signals;

FIG. 5 is an explanatory diagram of timings to read signals by the solid-state imaging apparatus according to the first embodiment;

FIG. 6 is an explanatory diagram of a course of reading signals from pixels in the pixel array;

FIG. 7 is an explanatory diagram of timings to read signals by a solid-state imaging apparatus according to a second embodiment;

FIG. 8 is an explanatory diagram of a course of reading signals from pixels in a pixel array;

FIG. 9 is a schematic configuration diagram of a pixel array included in a solid-state imaging apparatus according to a third embodiment;

FIG. 10 is an explanatory diagram of timings to read signals by the solid-state imaging apparatus according to the third embodiment; and

FIG. 11 is an explanatory diagram of a course of reading signals from pixels in the pixel array.

### DETAILED DESCRIPTION

In general, according to one embodiment, a solid-state imaging apparatus includes a pixel array, a first vertical signal line, a second vertical signal line, and a control unit. In the pixel array, cells are arrayed in a horizontal direction and a vertical direction. Each of cells includes a plurality of pixels. Each of the pixels accumulates therein signal charges corresponding to an amount of incident light. The first vertical signal line is connected to first cells. The second vertical signal line is connected to second cells. The first cells and the second cells constitute a column of cells. The control unit generates a timing signal. The timing signal is a signal for instructing timings to read signals from a plurality of pixels of each of the first cells to the first vertical signal line and timings to read signals from a plurality of pixels of each of the second cells to the second vertical signal line. In each of the cells, two pixels are arrayed in the horizontal direction and at least two pixels are arrayed in the vertical direction. The control unit orders pixels selected from the plurality of pixels to cause timings to read signals from the selected pixels to continue in the vertical direction. The control unit generates a timing signal that prioritizes ordering of the selected pixels over other pixels.

Exemplary embodiments of a solid-state imaging apparatus and a camera system will be explained below in detail with reference to the accompanying drawings. The present invention is not limited to the following embodiments.

### First Embodiment

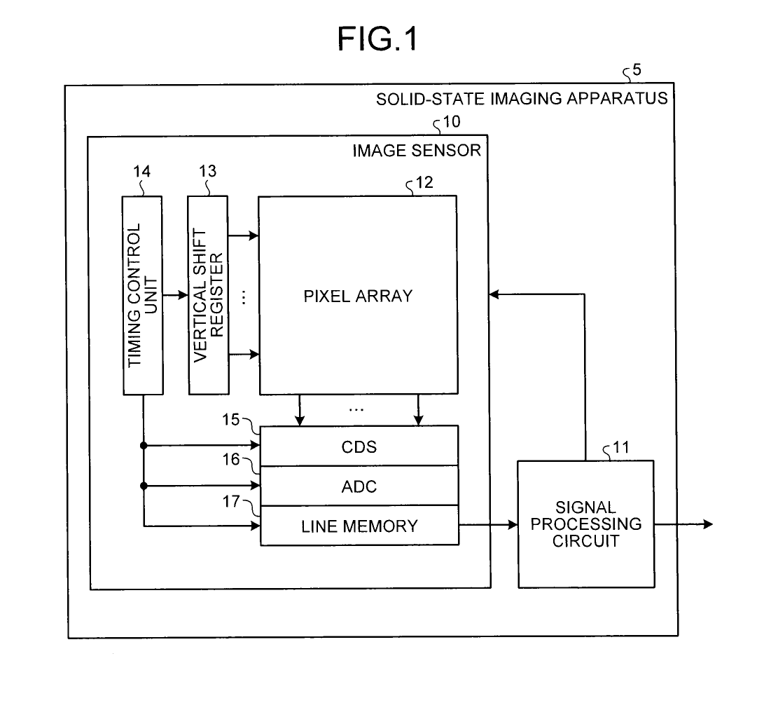

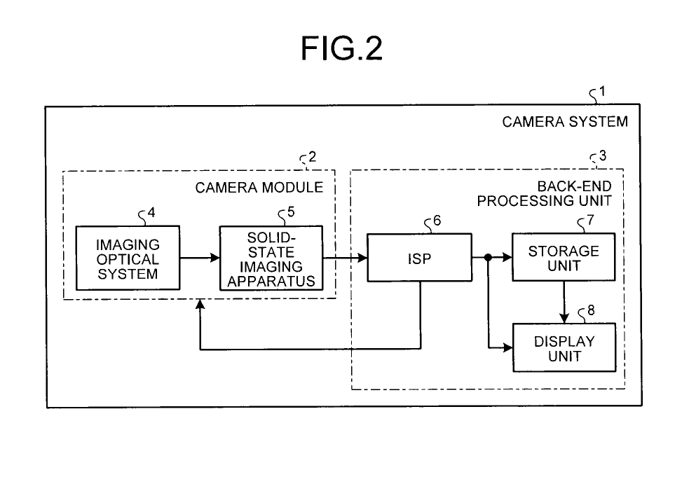

FIG. 1 is a block diagram illustrating a schematic configuration of a solid-state imaging apparatus according to a first embodiment. FIG. 2 is a block diagram illustrating a schematic configuration of a camera system including the solid-state imaging apparatus. A camera system 1 is, for example, a digital camera. The digital camera can be either a digital still camera or a digital video camera. The camera system 1 can be an electronic device including a camera module 2 (a camera-equipped portable terminal, for example) as well as the digital camera.

The camera system 1 includes the camera module 2 and a back-end processing unit 3. The camera module 2 has an imaging optical system 4 and a solid-state imaging apparatus 5. The back-end processing unit 3 includes an image signal processor (ISP) 6, a storage unit 7, and a display unit 8.

The imaging optical system 4 captures light from an object and provides an image of the object. The solid-state imaging apparatus 5 takes the image of the object. The ISP 6 serving as an image processing apparatus performs signal processing of an image signal obtained by image taking of the solid-state imaging apparatus 5. The storage unit 7 stores therein the image signal subjected to the signal processing by the ISP 6. The storage unit 7 outputs an image signal to the display unit 8 according to an operation of a user or the like.

The solid-state imaging apparatus 5 includes an image sensor 10 serving as an imaging element and a signal processing circuit 11 serving as a signal processing unit. The image sensor 10 is, for example, a complementary metal-oxide-semiconductor (CMOS) image sensor. The image sensor 10 has a pixel array 12, a vertical shift register 13, a timing control unit 14, a correlated double sampling unit (CDS) 15, an analog-digital converting unit (ADC) 16, and a line memory 17.

The pixel array 12 is provided in an imaging area of the image sensor 10. In the pixel array 12, pixels are arranged in a horizontal direction (a row direction) and a vertical direction (a column direction) in an array. Each of the pixels includes a photodiode serving as a photoelectric conversion element. The photoelectric conversion element generates signal charges corresponding to the amount of incident light. Each of the pixels accumulates therein the signal charges corresponding to the amount of incident light. A Bayer array is used as an array of pixels of respective colors in the vertical direction and the horizontal direction in the pixel array 12.

The timing control unit 14 serving as a control unit controls reading of signals from the pixels. The timing control unit 14 supplies a vertical synchronizing signal that indicates a timing of reading of signals from the pixels in the pixel array 12 to the vertical shift register 13. The timing control unit 14 supplies a timing signal that indicates a drive timing to each of the CDS 15, the ADC 16, and the line memory 17.

The vertical shift register 13 selects each horizontal line of pixels in the pixel array 12 according to the vertical synchronizing signal from the timing control unit 14. The vertical shift register 13 outputs a read signal to each of the pixels in the selected horizontal line. Each of the pixels to which the read signal has been input from the vertical shift register 13 outputs the accumulated signal charges. The pixel array 12 outputs signals from the pixels to the CDS 15 via vertical signal lines.

The CDS 15 performs correlated double sampling processing of the signals from the pixel array 12 to reduce fixed pattern noises. The ADC 16 converts the signals in an analog form into signals in a digital form. The line memory 17 accumulates therein the signals from the ADC 16. The image sensor 10 outputs the signals accumulated in the line memory 17.

The signal processing circuit 11 serving as a signal processing unit performs various types of signal processing to image signals from the image sensor 10. The signal processing circuit 11 performs various types of signal processing such as defect correction, gamma correction, noise reduction processing, lens shading correction, white balance adjustment, distortion correction, and resolution reconstruction.

The solid-state imaging apparatus 5 outputs the image signals subjected to the signal processing by the signal processing circuit 11 to outside of a chip. The solid-state imaging apparatus 5 executes a feedback control on the image sensor 10 based on data subjected to the signal processing by the signal processing circuit 11.

In the camera system 1, at least any of the various types of signal processing to be performed by the signal processing circuit 11 in the first embodiment can be performed by the ISP 6 of the back-end processing unit 3. In the camera system 1, at least any of the various types of signal processing can be performed both in the signal processing circuit 11 and the ISP 6. The signal processing circuit 11 and the ISP 6 can perform other types of signal processing than those explained in the first embodiment.

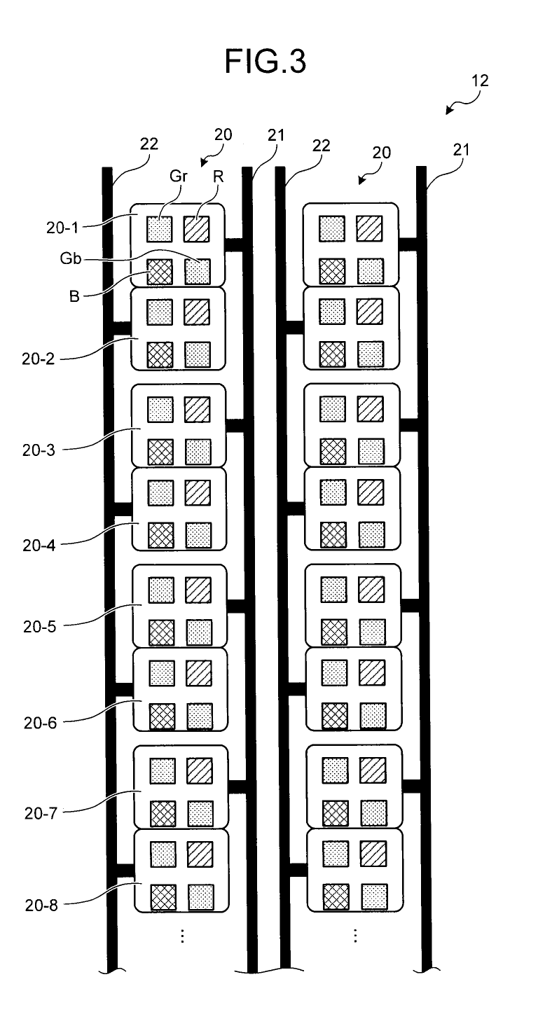

FIG. 3 is a schematic configuration diagram of the pixel array. In the pixel array 12, a plurality of cells 20 is arrayed in the horizontal direction and the vertical direction. Each of the cells 20 includes a plurality of pixels. In the first embodiment, two pixels are arrayed in the horizontal direction and two pixels are arrayed in the vertical direction in each of the cells 20.

These 2×2 pixels constituting each of the cells 20 share MOS transistors which are constituent elements of a pixel. This structure is hereinafter referred to as “2V2H-pixel sharing structure”. The four pixels adjacent to each other share, for example, a transfer transistor, a reset transistor, an amplifier transistor, and a row-select transistor as the MOS transistors. The MOS transistor performs amplification of an electric signal and a switching operation.

Because the pixel sharing structure is adopted, the image sensor 10 can reduce a pixel pitch as compared to a case where the MOS transistors are arranged for each of the pixels. The pixel sharing structure is suitable for downsizing the image sensor 10. With the pixel sharing structure, the solid-state imaging apparatus 5 can increase the quantity of saturation charges, enhance the sensitivity, and reduce random noises.

The 2×2 pixels constituting each of the cells 20 correspond to a pixel block as a unit of the Bayer array. In the Bayer array, a block of 2×2 pixels is a unit. A red (R) pixel and a blue (B) pixel are arranged at opposing corners of the pixel block, respectively, and two green (G) pixels are arranged at the remaining opposing corners thereof, respectively. Among the two G pixels included in the pixel block, one adjacent to the R pixel in the horizontal direction is referred to as a Gr pixel. Among the two G pixels included in the pixel block, one adjacent to the B pixel in the horizontal direction is referred to as a Gb pixel.

In the image sensor 10, two vertical signal lines 21 and 22 are arranged for each of columns of the cells 20 arrayed in the vertical direction. Among these, the vertical signal line 21 is a first vertical signal line connected to first cells. The vertical signal line 22 is a second vertical signal line connected to second cells. The timing control unit 14 generates a timing signal for indicating a timing when signals are to be read from plural pixels of the first cells to the vertical signal line 21 and a timing when signals are to be read from plural pixels of the second cells to the vertical signal line 22.

For example, among cells 20-1 to 20-8 arrayed in the vertical direction in a column of the cells 20, the cells 20-1, 20-3, 20-5, and 20-7 are connected to the vertical signal line 21. The cells 20-1, 20-3, 20-5, and 20-7 are the first cells. The cells 20-2, 20-4, 20-6, and 20-8 are connected to the vertical signal line 22. The cells 20-2, 20-4, 20-6, and 20-8 are the second cells. The first cells and the second cells are alternately arranged in the vertical direction.

In the case of the 2V2H-pixel sharing structure, the image sensor 10 cannot read signals from two pixels arranged in the horizontal direction in each cell 20 at the same time. The image sensor 10 reads a signal from the Gr pixel and a signal from the R pixel in each cell 20 at different timings. The image sensor 10 reads a signal from the B pixel and a signal from the Gb pixel in each cell 20 at different timings.

The image sensor 10 reads signals from the cells 20 connected to the vertical signal line 21 and signals from the cells 20 connected to the vertical signal line 22 in parallel. The image sensor 10 reads signals from a combination of one first cell and one second cell adjacent to each other in the vertical direction in parallel.

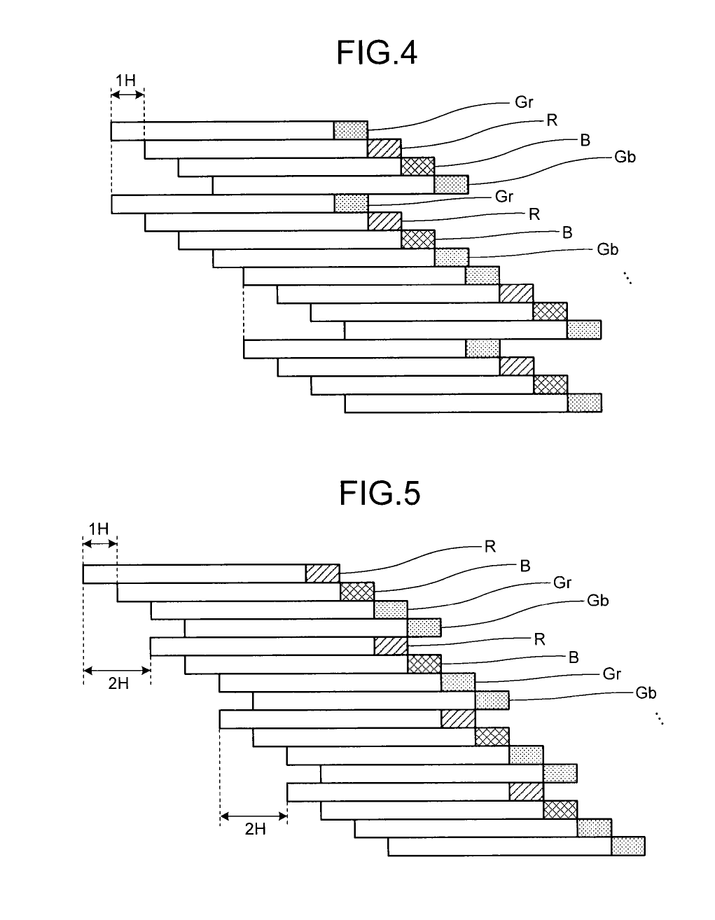

It is assumed that the image sensor 10 with this configuration reads signals by a conventional method in which a row of pixels arrayed in the horizontal direction is selected one by one in the vertical direction. FIG. 4 is an explanatory diagram of timings when an image sensor according to a comparative example reads signals.

In FIG. 4, a time from resetting of signal charges in each pixel to reading thereof is represented as a horizontal bar graph. A hatched portion on the right end of each bar graph represents a time when a signal is read from the pixel.

In the comparative example shown in FIG. 4, the image sensor 10 adopts a so-called rolling shutter method in which resetting of signal charges and reading thereof are performed by progressive scanning of each row. In the comparative example, the image sensor 10 reads signals according to an order rule to select pixels from top to bottom in the vertical direction and from left to right in the horizontal direction. According to this order rule, the image sensor 10 reads signals from four pixels in each of the cells 20 in an order of the Gr pixel and the R pixel in the first row and the B pixel and the Gb pixel in the second row. The image sensor 10 starts reading of signals from the first and second cells adjacent to each other in the vertical direction at the same time.

For example, the image sensor 10 reads a signal of the Gr pixel in the cell 20-1 and a signal of the Gr pixel in the cell 20-2 at the same time. After a time 1H passes, the image sensor 10 then reads a signal of the R pixel in the cell 20-1 and a signal of the R pixel in the cell 20-2 at the same time. Similarly, the image sensor 10 reads signals of the B pixel and signals of the Gb pixel in the cells 20-1 and 20-2.

The time 1H is a read time per row in the horizontal direction. For example, the image sensor 10 requires 1H to read a signal of each of the Gr pixels in one row including the Gr pixels. When the image sensor 10 ends reading of the signals of the cells 20-1 and 20-2, the image sensor 10 then reads signals of the cells 20-3 and 20-4 in the same manner. In this way, the image sensor 10 repeats reading of signals from the pixels in the cells 20.

As the scanning is advanced in the vertical direction, the image sensor 10 produces differences in read timings of the respective rows. When imaging a moving object that moves at a high speed, the image sensor 10 may cause distortion in an image of the moving object due to these differences.

In this comparative example, the image sensor 10 produces differences between the G pixels counter to the differences in read timings produced in the respective rows as the time passes. For example, as the scanning in the vertical direction is advanced from the cell 20-1 to the cell 20-2, the signal of the Gr pixel in the cell 20-2 is read a time 3H before the signal of the Gb pixel in the cell 20-1 is read. The time 3H is three times the length of the read time per row in the horizontal direction.

Because the read timings of the signals in each row are moved ahead or behind for the differences in the read timings produced in the respective rows, the image sensor 10 may cause noises (jaggies) in a pattern shape at boundary portions of the image of the moving object. Furthermore, the image sensor 10 may cause color deviation (false colors) in a demosaiced image because the differences in the read timings vary according to colors.

The image sensor 10 in which pixels of colors are arranged in the Bayer array detects more luminance information of an object in the G pixels than in the R pixels and the B pixels. In the image sensor 10, the differences in the read timings occurring between the G pixels greatly affect the image quality.

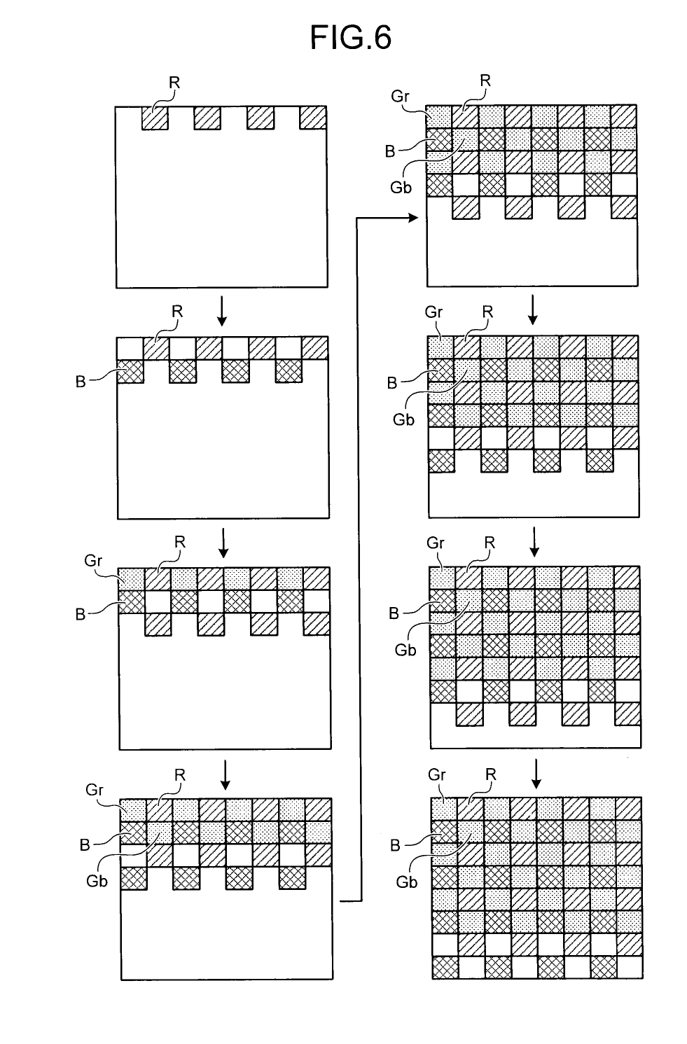

FIG. 5 is an explanatory diagram of timings to read signals by the solid-state imaging apparatus according to the first embodiment. FIG. 6 is an explanatory diagram of a course of reading signals from the pixels in the pixel array. In the first embodiment, the image sensor 10 changes the order of reading signals from the pixels with respect to the progressive scanning of each row by the rolling shutter method.

The timing control unit 14 generates a timing signal that prioritizes ordering of the G pixels over the R pixels and the B pixels to cause timings to read signals from the G pixels to continue in the vertical direction.

The G pixels are selected as pixels that have the maximum level of influence affected on the luminance of an image among the R, G, and B pixels as the pixels in the cells 20. The timing control unit 14 prioritizes ordering of the G pixels without complying with the order rule to select pixels from top to bottom in the vertical direction and from left to right in the horizontal direction.

For example, the timing control unit 14 sets the order of reading signals from the four pixels in each of the cells 20 as the R pixel in the first row, the B pixel in the second row, the Gr pixel in the first row, and the Gb pixel in the second row. The timing control unit 14 generates a timing signal to continuously read the signals from the G pixels among the pixels in each cell 20.

As for the first cell and the second cell adjacent to each other, the timing control unit 14 shifts a timing to read signals from the pixels in the second cell from a timing to read signals from the pixels in the first cell. The timing control unit 14 shifts periods during which the signals are read from the pixels of the first cell and the second cell adjacent to each other by a predetermined time, for example, 2H from each other. The time 2H is twice the length of the read time per row in the horizontal direction.

For example, the timing control unit 14 instructs reading of signals from the R pixels in the cells 20-1. According to such an instruction using the timing signal, the image sensor 10 reads the signals from the R pixels in the first row as shown in FIG. 6.

The timing control unit 14 delays a timing to read signals from the pixels in the cells 20-2 by the time 2H from the timing to read signals from the pixels in the cells 20-1. When reading the signals from the R pixels in the cells 20-1, the image sensor 10 does not perform reading of signals from the pixels in the cells 20-2.

The timing control unit 14 then instructs reading of signals from the B pixels in the cells 20-1. According to such an instruction using the timing signal, the image sensor 10 reads the signals from the B pixels in the second row. When reading the signals from the B pixels in the cells 20-1, the image sensor 10 does not perform reading of signals from the pixels in the cells 20-2.

The timing control unit 14 then instructs reading of signals from the Gr pixels in the cells 20-1 and signals from the R pixels in the cells 20-2. The timing control unit 14 starts the reading of the signals from the cells 20-2 with a delay of 2H from the timing to start the reading of the signals from the cells 20-1. According to such an instruction using the timing signal, the image sensor 10 reads the signals from the Gr pixels in the first row and the R pixels in the third row.

The timing control unit 14 then instructs reading of signals from the Gb pixels in the cells 20-1 and signals from the B pixels in the cells 20-2. According to such an instruction using the timing signal, the image sensor 10 reads the signals from the Gb pixels in the second row and the B pixels in the fourth row.

The timing control unit 14 also thereafter instructs reading of signals from the cells 20-2 and 20-3 and the subsequent cells while shifting starts of reading of signals of the first cell and the second cell from each other by 2H. In this way, the image sensor 10 repeats reading of signals from the pixels in the cells 20.

The image sensor 10 continuously reads the signal from the Gr pixel and the signal from the Gb pixel in each of the cells 20. The image sensor 10 shifts the periods during which signals are read from the pixels of the first cell and the second cell from each other, thereby reading the signal from the Gr pixel and the signal from the Gb pixel in an order according to scanning in the vertical direction.

As described above, the timing control unit 14 prioritizes ordering so that the timing to read the signals from the Gr pixels and the timing to read the signals from the Gb pixels continue in the scanning in the vertical direction.

As compared to the comparative example mentioned above, the image sensor 10 in the first embodiment can eliminate the differences between the G pixels counter to the differences in read timings occurring in the respective rows as the time passes. The solid-state imaging apparatus 5 can reduce occurrence of jaggies and false colors by reducing the differences in read timings with respect to the G pixels that detect more luminance information of an object. Accordingly, the solid-state imaging apparatus 5 can reduce degradation of image quality due to the differences in read timings of signals.

The timing control unit 14 can appropriately change the order of reading the pixels in the cells 20. The timing control unit 14 can appropriately interchange the read timings between the Gr pixel and the Gb pixel. The timing control unit 14 can appropriately interchange the read timings between the R pixel and the B pixel.

The timing control unit 14 can prioritize ordering of pixels other than the G pixels. For example, when W pixels that capture white light are included in the pixel array 12, the timing control unit 14 can select the W pixels as pixels of which ordering is to be prioritized.

The W pixels capture light of a wavelength band larger than other color pixels and thus have a larger level of influence affected on the luminance of an image than other color pixels. The solid-state imaging apparatus 5 can reduce degradation of image quality by reducing differences in read timings from the W pixels that detect more luminance information of an object.

### Second Embodiment

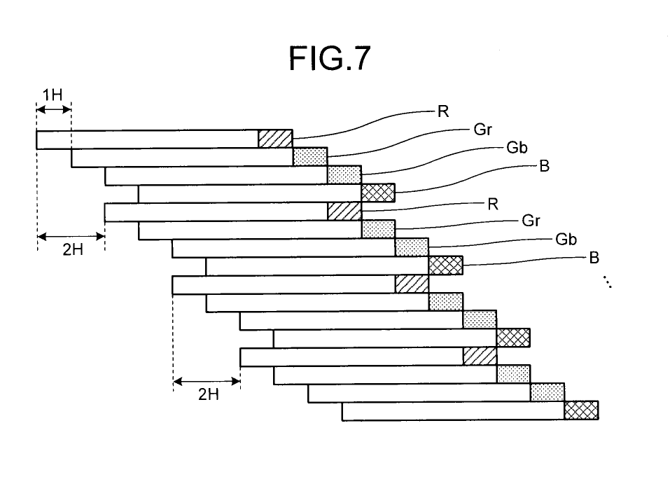

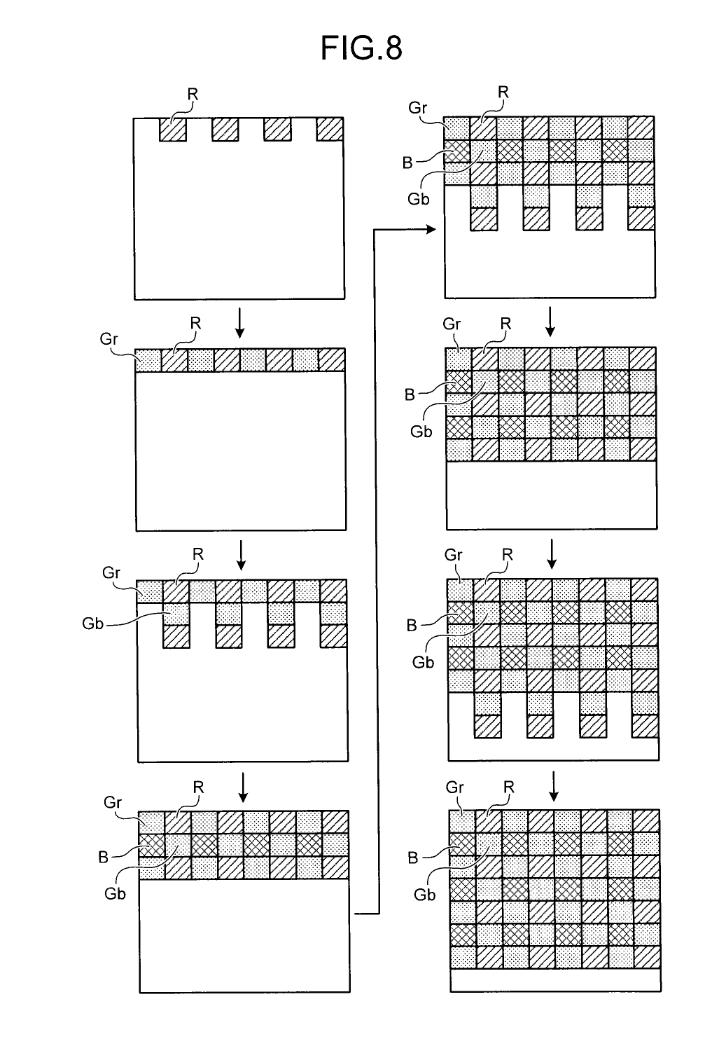

FIG. 7 is an explanatory diagram of timings to read signals by a solid-state imaging apparatus according to a second embodiment. FIG. 8 is an explanatory diagram of a course of reading signals from pixels in a pixel array. The solid-state imaging apparatus according to the second embodiment has configurations identical to those of the first embodiment. In the second embodiment, constituent elements identical to those of the first embodiment are denoted by like reference signs and redundant explanations thereof will be appropriately omitted.

Similarly to the first embodiment, the timing control unit 14 generates a timing signal that prioritizes ordering of the G pixels over the R pixels and the B pixels to cause timings to read signals from the G pixels to continue in the vertical direction.

For example, the timing control unit 14 sets an order of reading signals from the four pixels in each cell 20 as the R pixel in the first row, the Gr pixel in the first row, the Gb pixel in the second row, and the B pixel in the second row. The timing control unit 14 generates the timing signal to continuously read signals from the G pixels among the pixels in each cell 20.

As for the first cell and the second cell adjacent to each other, the timing control unit 14 shifts a timing to read signals from the pixels in the second cell from a timing to read signals from the pixels in the first cell. The timing control unit 14 shifts periods during which the signals are read from the pixels of the first cell and the second cell adjacent to each other by a predetermined time, for example, 2H from each other. The time 2H is twice the length of the read time per row in the horizontal direction.

For example, the timing control unit 14 instructs reading of signals from the R pixels in the cells 20-1. According to such an instruction using the timing signal, the image sensor 10 reads the signals from the R pixels in the first row as shown in FIG. 8.

The timing control unit 14 then instructs reading of signals from the Gr pixels in the cells 20-1. According to such an instruction using the timing signal, the image sensor 10 reads the signals from the Gr pixels in the first row.

The timing control unit 14 delays a timing to read signals from the pixels in the cells 20-2 by the time 2H from a timing to read signals from the pixels in the cells 20-1. When reading signals from the R pixels and the Gr pixels in the cells 20-1, the image sensor 10 does not perform reading of signals from the pixels in the cells 20-2.

The timing control unit 14 then instructs reading of signals from the Gb pixels in the cells 20-1 and signals from the R pixels in the cells 20-2. The timing control unit 14 starts reading of signals from the cells 20-2 with a delay of 2H from a timing to start reading of signals from the cells 20-1. According to such an instruction using the timing signal, the image sensor 10 reads signals from the Gb pixels in the second row and the R pixels in the third row.

The timing control unit 14 then instructs reading of signals from the B pixels in the cells 20-1 and signals from the Gr pixels in the cells 20-2. According to such an instruction using the timing signal, the image sensor 10 reads the signals from the B pixels in the second row and the Gr pixels in the third row.

The timing control unit 14 also thereafter instructs reading of signals from the cells 20-2 and 20-3 and the subsequent cells while shifting starts of reading of signals of the first cell and the second cell from each other by 2H. In this way, the image sensor 10 repeats reading of signals from the pixels of the cells 20.

Also in the second embodiment, the image sensor 10 continuously reads the signal from the Gr pixel and the signal from the Gb pixel in each of the cells 20. The image sensor 10 reads the signal from the Gr pixel and the signal from the Gb pixel in an order according to scanning in the vertical direction by shifting the periods during which signals are read from the pixels of the first cell and the second cell from each other.

In this way, the timing control unit 14 prioritizes ordering so that the timing to read signals from the Gr pixels and the timing to read signals from the Gb pixels continue in scanning in the vertical direction. Also in the second embodiment, the image sensor 10 can eliminate the differences between the G pixels counter to the differences in the read timings occurring in the respective rows as the time passes.

Also in the second embodiment, the solid-state imaging apparatus 5 can reduce occurrence of jaggies and false colors by reducing the differences in the read timings with respect to the G pixels that detect more luminance information of an object. Accordingly, the solid-state imaging apparatus 5 can reduce degradation in image quality due to the differences in the read timings of signals.

The timing control unit 14 can appropriately change the order of reading the pixels in the cells 20. The timing control unit 14 can appropriately interchange the read timings between the Gr pixel and the Gb pixel. The timing control unit 14 can appropriately interchange the read timings between the R pixel and the B pixel.

The timing control unit 14 can prioritize ordering of pixels other than the G pixels. For example, the W pixels that capture white light are included in the pixel array 12, the timing control unit 14 can select the W pixels as pixels of which ordering is to be prioritized.

### Third Embodiment

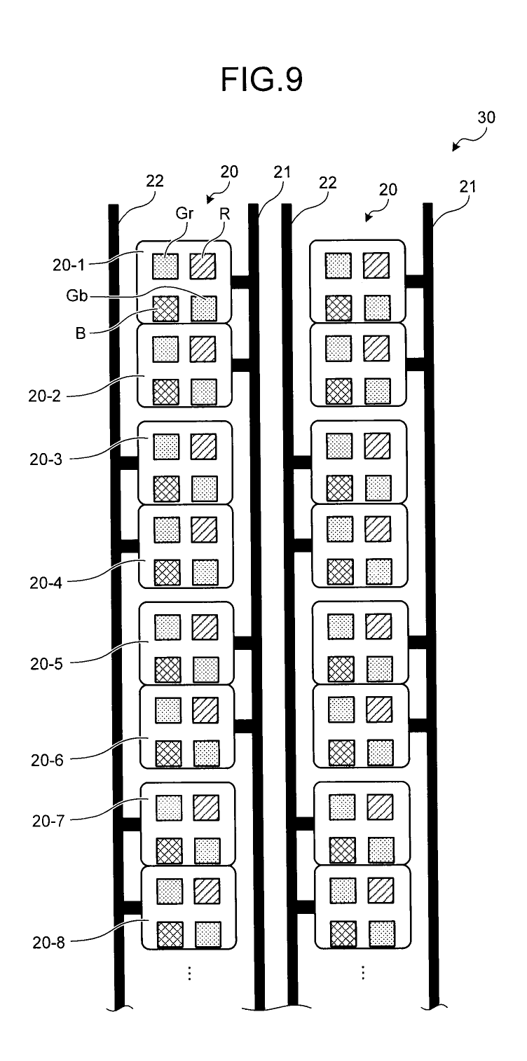

FIG. 9 is a schematic configuration diagram of a pixel array included in a solid-state imaging apparatus according to a third embodiment. In the third embodiment, constituent elements identical to those of the first embodiment are denoted by like reference signs and redundant explanations thereof will be appropriately omitted.

In each of the cells 20, two pixels are arrayed in the horizontal direction and two pixels are arrayed in the vertical direction. In the image sensor 10, the two vertical signal lines 21 and 22 are arranged for each column of the cells 20 arrayed in the vertical direction.

In a pixel array 30, two cells 20 adjacent to each other are connected to the same vertical signal line 21 or 22. For example, among the cells 20-1 to 20-8 arrayed in the vertical direction in a column of the cells 20, the cells 20-1, 20-2, 20-5, and 20-6 are connected to the vertical signal line 21.

For example, a combination of the cells 20-1 and 20-2 adjacent to each other can be regarded as one cell in which two pixels are arrayed in the horizontal direction and four pixels are arrayed in the vertical direction. The combination of the cells 20-1 and 20-2 includes a configuration equivalent to a 4V2H-pixel sharing structure. The combination of the cells 20-1 and 20-2 and a combination of the cells 20-5 and 20-6 are assumed as the first cells, respectively.

The cells 20-3, 20-4, 20-7, and 20-8 are connected to the vertical signal line 22. A combination of the cells 20-3 and 20-4 and a combination of the cells 20-7 and 20-8 are assumed as the second cells, respectively. The first cells and the second cells are arranged alternately in the vertical direction.

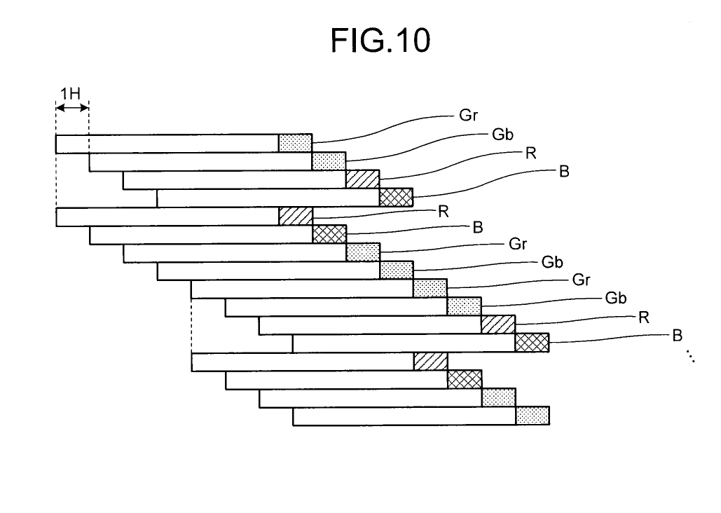

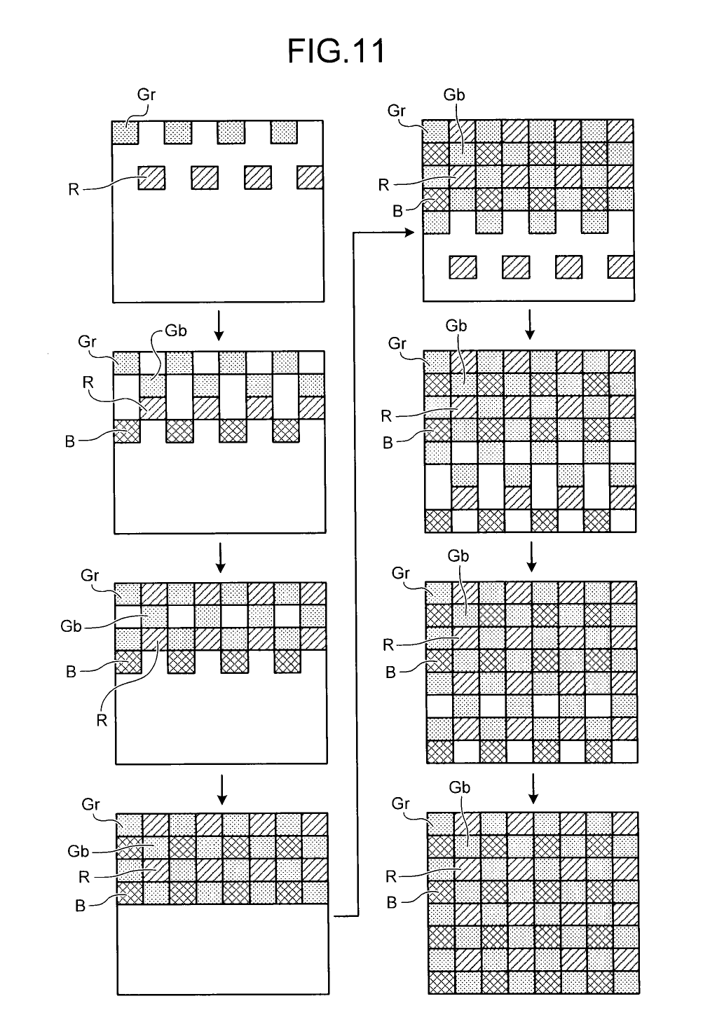

FIG. 10 is an explanatory diagram of timings to read signals by a solid-state imaging apparatus according to the third embodiment. FIG. 11 is an explanatory diagram of a course of reading signals from pixels in the pixel array.

The timing control unit 14 generates a timing signal that prioritizes ordering of the G pixels over the R pixels and the B pixels to cause timings to read signals from the G pixels to continue in the vertical direction.

For example, with respect to each of the cells 20-1 and 20-5 from which signals are read first among the first cells, the timing control unit 14 reads signals from the R pixel in the first row, the B pixel in the second row, the Gr pixel in the first row, and the Gb pixel in the second row in this order. With respect to each of the cells 20-2 and 20-6 from which signals are read later among the first cells, the timing control unit 14 reads signals from the Gr pixel in the first row, the Gb pixel in the second row, the R pixel in the first row, and the B pixel in the second row in this order.

With respect to each of the cells 20-3 and 20-7 from which signals are read first among the second cells, the timing control unit 14 reads signals from the R pixel in the first row, the B pixel in the second row, the Gr pixel in the first row, and the Gb pixel in the second row in this order. With respect to each of the cells 20-4 and 20-8 from which signals are read later among the second cells, the timing control unit 14 reads signals from the Gr pixel in the first row, the Gb pixel in the second row, the R pixel in the first row, and the B pixel in the second row in this order. The timing control unit 14 generates a timing signal to continuously read the signals from the G pixels among the pixels in the cells 20.

With respect to the first cell and the second cell adjacent to each other, the timing control unit 14 shifts a timing to read signals from the pixels in the second cell from a timing to read signals from the pixels in the first cell. The timing control unit 14 shifts periods during which signals are read from the pixels of the first cell and the second cell adjacent to each other by a predetermined time, for example, 4H from each other. The time 4H is four times the length of the read time per row in the horizontal direction.

The timing control unit 14 delays a timing to read signals from the pixels in the second cells by the time 4H from a timing to read signals from pixels in the first cells. For example, the image sensor 10 does not perform reading of the signals from the pixels in the second cells while reading the signals from the pixels in the cells 20-1 as the first cells.

The timing control unit 14 then instructs reading of signals from the Gr pixels in the cells 20-2 as the first cells and signals from the R pixels in the cells 20-3 as the second cells. The timing control unit 14 starts reading of the signals from the cells 20-3 as the second cells with a delay of 4H from a timing to start reading of the signals from the cells 20-1 as the first cells.

FIG. 10 is an explanatory diagram of timings starting from a time when the signals from the Gr pixels in the cells 20-2 and the signals from the R pixels in the cells 20-3 are read at the same time. FIG. 11 is an explanatory diagram of a course starting from a time when the signals from the Gr pixels in the cells 20-2 and the signals from the R pixels in the cells 20-3 are read at the same time. According to such an instruction using the timing signal, the image sensor 10 reads the signals from the Gr pixels in the first row and the R pixels in the third row.

The timing control unit 14 then instructs reading of signals from the Gb pixels in the cells 20-2 and signals from the B pixels in the cells 20-3. According to such an instruction using the timing signal, the image sensor 10 reads signals from the Gb pixels in the second row and the B pixels in the fourth row.

The timing control unit 14 then instructs reading of signals from the R pixels in the cells 20-2 and signals from the Gr pixels in the cells 20-3. According to such an instruction using the timing signal, the image sensor 10 reads signals from the R pixels in the first row and the Gr pixels in the third row.

The timing control unit 14 then instructs reading of signals from the B pixels in the cells 20-2 and signals from the Gb pixels in the cells 20-3. According to such an instruction using the timing signal, the image sensor 10 reads signals from the B pixels in the second row and the Gb pixels in the fourth row.

The timing control unit 14 thereafter instructs reading of signals from the cells 20-2 and 20-3 and the subsequent cells while shifting starts of reading of signals of the first and second cells from each other by 4H. In this way, the image sensor 10 repeats reading of signals from the pixels in the cells 20.

Also in the third embodiment, the image sensor 10 continuously reads the signal from the Gr pixel and the signal from the Gb pixel in each of the cells 20. The image sensor 10 reads the signal from the Gr pixel and the signal from the Gb pixel in an order according to scanning in the vertical direction by shifting the periods during which signals are read from the pixels of the first and second cells from each other.

In this way, the timing control unit 14 prioritizes ordering with respect to scanning in the vertical direction so that the timing to read signals from the Gr pixels and the timing to read signals from the Gb pixels continue. Also in the third embodiment, the image sensor 10 can eliminate the differences between the G pixels counter to the differences in read timings occurring in the respective rows as the time passes.

Also in the third embodiment, the solid-state imaging apparatus 5 can reduce occurrence of jaggies and false colors by reducing the differences in read timings with respect to the G pixels that detect more luminance information of an object. Accordingly, the solid-state imaging apparatus 5 can reduce degradation in image quality due to the differences in read timings of signals.

In the third embodiment, the solid-state imaging apparatus 5 can perform binning processing for reducing the amount of data in the vertical direction. For example, the timing control unit 14 generates a timing signal to simultaneously select two pixels of a same color in the vertical direction. The solid-state imaging apparatus 5 averages charges simultaneously read from two cells 20 using the vertical signal lines 21 and 22. Accordingly, the solid-state imaging apparatus 5 halves the amount of data in the vertical direction.

The solid-state imaging apparatus 5 can read an image at a high speed by reducing the amount data to be read for each frame. The solid-state imaging apparatus 5 can perform image processing by reducing the amount of data for each frame.

The timing control unit 14 can appropriately change the order of reading the pixels in the cells 20. The timing control unit 14 can appropriately interchange the read timings between the Gr pixel and the Gb pixel. The timing control unit 14 can appropriately interchange the read timings between the R pixel and the B pixel.

The timing control unit 14 can prioritize ordering of pixels other than the G pixels. For example, W pixels that capture white light are included in the pixel array 30, the timing control unit 14 can select the W pixels as pixels of which ordering is to be prioritized.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging apparatus comprising:
a pixel array in which cells each including a plurality of pixels each of which accumulates therein signal charges corresponding to an amount of incident light are arrayed in a horizontal direction and a vertical direction;
a first vertical signal line connected to first cells that constitute a column of the cells arrayed in the vertical direction;
a second vertical signal line connected to second cells that constitute the column of the cells; and
a control unit that generates a timing signal for instructing timings to read signals from the plurality of pixels of each of the first cells to the first vertical signal line, and timings to read signals from the plurality of pixels of each of the second cells to the second vertical signal line, wherein
two of the pixels are arrayed in the horizontal direction and at least two of the pixels are arrayed in the vertical direction in each of the cells, and
the control unit generates the timing signal that prioritizes ordering of pixels selected from the plurality of pixels over other pixels to cause timings to read signals from the selected pixels to continue in the vertical direction.

2. The solid-state imaging apparatus according to claim 1, wherein with respect to the first and second cells adjacent to each other, the control unit shifts timings to read signals from the plurality of pixels of each of the second cells from timings to read signals from the plurality of pixels of each of the first cells.

3. The solid-state imaging apparatus according to claim 1, wherein the control unit generates the timing signal to continuously read signals from the selected pixels among the plurality of pixels.

4. The solid-state imaging apparatus according to claim 1, wherein the selected pixels are green pixels that detect green light.

5. The solid-state imaging apparatus according to claim 4, wherein the control unit generates the timing signal to continuously read signals from the green pixels included in each of the cells.

6. The solid-state imaging apparatus according to claim 1, wherein
two of the pixels are arrayed in the horizontal direction and two of the pixels are arrayed in the vertical direction in each of the cells,
the first cells and the second cells are alternately arrayed in the vertical direction, and
the control unit shifts a period during which signals are read from the plurality of pixels of each of the first cells from a period during which signals are read from the plurality of pixels of corresponding one of the second cells adjacent to the first cell by twice a length of a read time per row in the horizontal direction.

7. The solid-state imaging apparatus according to claim 1, wherein
two of the pixels are arrayed in the horizontal direction and two of the pixels are arrayed in the vertical direction in each of the first and second cells,
the first cells and the second cells are alternately arrayed in the vertical direction, and
the control unit shifts a period during which signals are read from the plurality of pixels of each of the first cells and a period during which signals are read from the plurality of pixels of corresponding one of the second cells adjacent to the first cell by four times a length of a read time per row in the horizontal direction.

8. The solid-state imaging apparatus according to claim 7, wherein the control unit generates the timing signal to simultaneously select plural pixels of a same color in the vertical direction.

9. The solid-state imaging apparatus according to claim 1, wherein the selected pixels are pixels that detect white light.

10. A camera system comprising:
an imaging optical system that captures light from an object and provides an image of the object;
a pixel array in which cells each including a plurality of pixels each of which accumulates therein signal charges corresponding to an amount of incident light from the imaging optical system are arrayed in a horizontal direction and a vertical direction;
a first vertical signal line connected to first cells that constitute a column of the cells arrayed in the vertical direction;
a second vertical signal line connected to second cells that constitute the column of the cells; and
a control unit that generates a timing signal for instructing timings to read signals from the plurality of pixels of each of the first cells to the first vertical signal line, and timings to read signals from the plurality of pixels of each of the second cells to the second vertical signal line, wherein
two of the pixels are arrayed in the horizontal direction and at least two of the pixels are arrayed in the vertical direction in each of the cells, and
the control unit generates the timing signal that prioritizes ordering of pixels selected from the plurality of pixels over other pixels to cause timings to read signals from the selected pixels to continue in the vertical direction.

11. The camera system according to claim 10, wherein with respect to the first and second cells adjacent to each other, the control unit shifts timings to read signals from the plurality of pixels of each of the second cells from timings to read signals from the plurality of pixels of each of the first cells.

12. The camera system according to claim 10, wherein the control unit generates the timing signal to continuously read signals from the selected pixels among the plurality of pixels.

13. The camera system according to claim 10, wherein the selected pixels are green pixels that detect green light.

14. The camera system according to claim 13, wherein the control unit generates the timing signal to continuously read signals from the green pixels included in each of the cells.

15. The camera system according to claim 10, wherein
two of the pixels are arrayed in the horizontal direction and two of the pixels are arrayed in the vertical direction in each of the cells,
the first cells and the second cells are alternately arrayed in the vertical direction, and
the control unit shifts a period during which signals are read from the plurality of pixels of each of the first cells from a period during which signals are read from the plurality of pixels of corresponding one of the second cells adjacent to the first cell by twice a length of a read time per row in the horizontal direction.

16. The camera system according to claim 10, wherein
two of the pixels are arrayed in the horizontal direction and two of the pixels are arrayed in the vertical direction in each of the first and second cells,
the first cells and the second cells are alternately arrayed in the vertical direction, and
the control unit shifts a period during which signals are read from the plurality of pixels of each of the first cells and a period during which signals are read from the plurality of pixels of corresponding one of the second cells adjacent to the first cell by four times a length of a read time per row in the horizontal direction.

17. The camera system according to claim 16, wherein the control unit generates the timing signal to simultaneously select plural pixels of a same color in the vertical direction.

18. The camera system according to claim 10, wherein the selected pixels are pixels that detect white light.
